(19) United States
(12) Patent Application Publication
(10) Pub. No.: US 2020/0165103 A1
(43) Pub. Date: May 28, 2020

(54) IMPROVEMENTS IN OR RELATING TO STAIRLIFTS

(71) Applicant: Stannah Stairlifts Limited, Hampshire (GB)

(72) Inventors: Nigel Titchener, Andover Hampshire (GB); Paul Alexander Cook, Shrewton Wiltshire (GB)

(21) Appl. No.: 16/637,431

(22) PCT Filed: Jul. 31, 2018
(86) PCT No.: PCT/GB2018/052176

§ 371 Date: Feb. 7, 2020

(30) Foreign Application Priority Data
Aug. 9, 2017 (GB) 1712745.7

(51) Int. Cl. B66B 9/08; B66B 1/30; B66B 5/02; B66B 5/00

(52) U.S. Cl. CPC B66B 9/08; B66B 5/0031; B66B 5/02; B66B 1/30

(57) ABSTRACT

The invention describes a method of ensuring the integrity of a stairlift installation constructed from re-used components. Data representative of the form of a stairlift rail is stored in a control facility included in the stairlift carriage and then compared with data sensed in real time. A stairlift carriage may be disabled in the event sensed data varies from stored data.

REFERENCE TO RELATED APPLICATIONS

This application is a U.S. national stage application of PCT/GB2018/052176, filed Jul. 31, 2018, which claims priority to Great Britain application No. GB1712745.7, filed Aug. 9, 2017, the entire content of both of which is incorporated herein by reference.

### FIELD OF THE INVENTION

This invention relates to stairlifts and, in particular, to a method of and/or apparatus for, ensuring the safety or integrity of a stairlift installation.

### FIELD OF THE INVENTION

A stairlift is a safety critical piece of equipment. Manufacturers of stairlifts are required to comply with strict standards governing design and construction and installation but, once a stairlift has been installed, there is little or no control over the subsequent treatment of the product. The potential problems that arise from this are exacerbated by a trend towards supplying stairlift rails assembled from a kitset of standard components as described in International Patent Applications WO92/20604, WO99/46198 & WO2011/064582. With this trend, any person, regardless of skill, can readily source second-hand stairlift carriage and rail parts and perform a stairlift installation. Not only does this expose stairlift users to uncontrolled risk but, in the event of failure, that failure will inevitably be associated with the original equipment manufacturer even though it may result from the second-hand installer.

It is an object of the invention to provide a method and/or apparatus which will go at least some way in addressing the aforementioned problems; or which will at least provide a novel and useful choice,

### SUMMARY OF THE INVENTION

Accordingly, in a first aspect, the invention provides a method of controlling the operation of a stairlift comprising a stairlift carriage operable to move along, a stairlift rail wherein said rail has defined fixed parameters upon installation, said method being characterised by configuring a control facility within said carriage to monitor at least one of said defined fixed parameters and to respond upon a variation in said at least one of said defined parameters being detected.

Preferably said carriage or a chair mounted on said carriage is provided with one or more sensors operable to sense data comparable with said defined fixed parameters, said method including comparing in real time, data derived from said sensors with said defined parameters and responding in the event of a variation there-between.

Preferably said defined fixed parameters include a length of said stairlift rail.

Preferably said defined fixed parameters include a position or an angle of a bend at a de med position along said stairlift rail, or a sequence of angles and/or bend types.

Preferably said defined fixed parameters include an inclination said stairlift rail at a defined position along said stairlift rail.

Preferably said defined fixed parameters ares established during the design of said stairlift rail and subsequently transferred to said control facility.

Alternatively said defined fixed parameters are programmed into said control facility at time of installation of said carnage onto said rail at a place of use.

Preferably said defined fixed parameters are established following a defined number of journeys of said stairlift carriage along said stairlift rail.

Preferably said stairlift carriage is configured to respond to a change in said defined fixed parameters by ceasing to operate.

In a second aspect the invention provides a stairlift comprising a stairlift carriage operable to move along a stairlift rail having defined fixed parameters upon installation, said stairlift being characterised in that said carriage includes a control facility configured to monitor said defined fixed parameters and to respond upon detecting a variation in at least one of said defined fixed parameters.

Preferably said stairlift is configured according to the method set forth above.

Many variations in the way the present invention can be performed will present themselves to those skilled in the art. The description which follows is intended as, an illustration only of one means of performing the invention and the lack of description of variants or equivalents should not be regarded as limiting. Subject to the falling within the scope of the appended claims, wherever possible, a description of a specific element should be deemed to include any and all equivalents thereof whether in existence now or in the future.

### BRIEF DESCRIPTION OF THE DRAWING

One form of the invention will now be described with reference to the accompanying drawing in which:

FIGURE is an isometric, schematic, view of a stairlift installation.

### DETAILED DESCRIPTION OF THE INVENTION

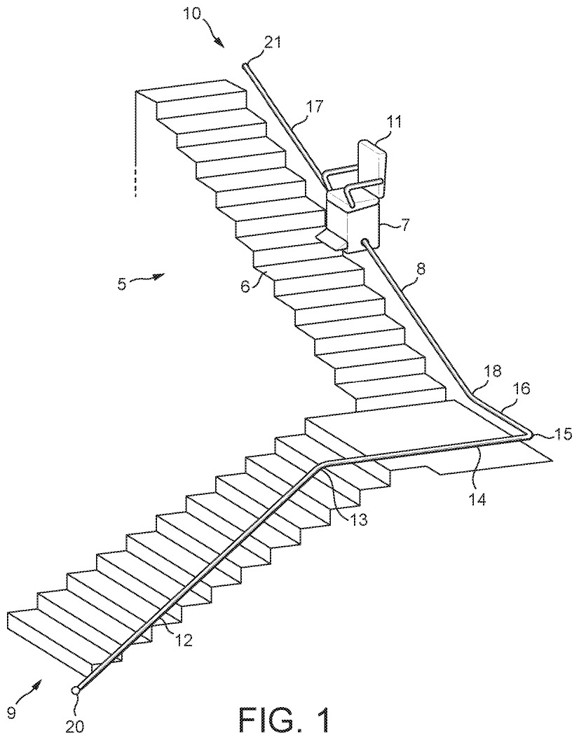

As shown in FIG. 1, the stairlift 5 is mounted along one edge of staircase 6 and comprises a stairlift carriage 7 mounted on a stairlift rail 8 for movement along the rail between a lower end 9 and an upper end 10. In the conventional manner a chair 11 is mounted on the carriage upon which, in use, a user is seated.

In the form shown, the rail 8 comprises a first upwardly inclined section 12 passing through a negative transition bend 13 into a first horizontal section 14. The first horizontal section 14 terminates in an inside bend 15 that, in turn, leads into a second horizontal section 16, the section 16 leading into a second upwardly inclined section 17 through positive transition bend 18.

Conventionally, for a battery-powered stairlift, battery charge points 20 and 21 are provided at or adjacent to the rail ends 9 and 10 respectively.

Mapping of a stairlift rail is known in the art and is broadly described in our European Patent No. 0 728 232. That is to say, it is known to store in an electronic memory fixed parameters such as the lengths of the various rail sections and the manner in which adjacent sections merge into one another. The present invention uses this mapping concept along with one or more sensors monitoring data derived while the carriage 7 is moving along the rail 8, in real time, to determine if the path being followed by the carriage is a departure from the map. If so, then it is assumed that the carriage has been moved onto a different rail and, in this event, the carriage is programmed to cease functioning.

The data sensed and recorded as the carriage moves along the rail preferably includes distance travelled from an end of the rail, and rail inclination,

Alternatively, or in addition, it may include bend type e.g. positive transition, negative transition, inside or outside and/or a sequence in which particular types of bend and/or angles of bend arise. The data may also include the position or positions at which particular types of bend are located along the length of the rail.

Distance is conveniently measured using an encoder and inclination measured using any suitable inclinometer.

In a first simple embodiment of the invention, a control facility (not shown) such as electronic control unit (ECU) within the carriage 7 is programmed with the distance between charge points 20 and 21. During real-time operation of the stairlift, if this distance is found to vary, then a fault is indicated and the carriage will cease to function. In more sophisticated embodiments the carriage ECU is programmed to check distance from a prescribed datum, for example the lower end 9 of the rail, and inclination sensed in real time at various points during its travel along the rail. The ECU may also be programmed with a particular sequence of rail angles or bend types. This data is then compared within the ECU with corresponding data of the stored map and, again, if there is variance between what is sensed and what is stored, then the ECU is programmed to disable the carriage.

In the event a variation is established between what is sensed and what is stored, the carriage is preferably disabled on the next occasion it arrives at the lower end 9 of the rail.

It is to be emphasised that the invention involves comparing real time data with stored data representing fixed parameters of a stairlift rail, and real time data gathering should be programed to overlook rail configuration variances arising from real time movement of components on the rail. An example of such a variance is a folding rail section that is included in some stairlift installations, an example of which is shown in published PCT Patent Application No. WO 2013/137730.

The mapped data may be entered into the ECU of the carriage at the time of installation of the stairlift by running the carriage up and down the bespoke rail so that the inclinations and lengths of the various rail sections can be learned and stored. After a fixed number of runs up and down the rail, the ECU ‘locks’ the learning function arid the carriage is then bound to that rail configuration. If there is a subsequent change to the rail which involves an alteration to the path of the rail, then the ECU is programmed not to learn or map the new path.

As an alternative to the mapping-on-installation procedure described above, data representing a rail map may be generated during, the rail design process familiar to all manufacturers of stairlifts and this data may be represented by a multi-digit code in which the particular combination of digits represents a particular combination of rail sections and bends. As well, the ECU in the carriage or chair is programmed to decrypt the code and, thereby, ‘learn’ the rail profile.

For example the rail design process may generate an encrypted 4-digit code that describes elements of the rail to be installed and that code will preferably be displayed on the installation drawing given to the installer. At installation the installer accesses the ECU in the stairlift and enters the code. The carriage software then undertakes the decryption and, in so doing, acquires the rail map corresponding to that code. The installer then runs the carriage along the rail so that the sensors can establish real time data, compare this to the map, and determine if the rail is an authorised rail. Thereafter the ECU is programmed to periodically re-check to ensure that the rail still conforms to the map and if a variance is found, the ECU disables the carriage.

1. A method of controlling the operation of a stairlift comprising;
providing a stairlift carriage operable to move along a stairlift rail wherein said rail has defined fixed parameters upon installation; and
configuring a control facility within said carriage to monitor at least one of said defined fixed parameters and to respond upon a variation in said at least one of said defined parameters being detected.

2. The method as claimed in claim 1, wherein said carriage or a chair mounted on said carriage is provided with one or more sensors operable to sense data comparable with said defined fixed parameters, said method including comparing in real time, data derived from said sensors with said defined fixed parameters and responding in the event of a variation there-between

3. The method as claimed in claim 1, wherein said defined fixed parameters include a length of said stairlift rail.

4. The method as claimed in claim 1, wherein said defined fixed parameters include a position or an angle of a bend at a defined position along, said stairlift rail, or a sequence of angles or bend types.

5. The method as claimed in claim 1, wherein said defined fixed parameters include an inclination of said stairlift rail at a defined position along said stairlift rail.

6. The method as claimed in claim 1, wherein said defined fixed parameters are established during the design of said stairlift rail and subsequently transferred to said control facility.

7. The method as claimed in claim 1, wherein said defined fixed parameters are programmed into said control facility at time of installation of said carriage onto said rail at a place of use.

8. The method as claimed in claim 7, wherein said defined fixed parameters are established following a defined number of journeys of said stairlift carriage along said stairlift rail.

9. The method as claimed in claim 1, wherein said control facility is configured to respond to a change in said defined fixed parameters by ceasing to operate.

10. A stairlift comprising:
a stairlift carriage operable to move along a stairlift rail having defined fixed parameters upon installation; and a
control facility within said carriage configured to monitor said defined fixed parameters and to respond upon detecting a Variation in at least one of said defined fixed parameters.
